(19) United States
(12) Patent Application Publication
(10) Pub. No.: US 2009/0277887 A1
(43) Pub. Date: Nov. 12, 2009

(54) JOINT METHOD USING LASER BEAM AND MANUFACTURING METHOD OF AIRTIGHT CONTAINER

(75) Inventor: Kosuke Kurachi, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/430,394

(22) Filed: Apr. 27, 2009

(30) Foreign Application Priority Data
May 9, 2008 (JP) 2008-123438

(51) Int. Cl. B23K 26/20

(52) U.S. Cl. 219/121.64

(57) ABSTRACT

Provided is a manufacturing method for an airtight container excelling in airtightness and adhesion and having small stress. An area where temperature easily rises compared to an area adjacent to an area of a part of a joint member and capable of melting the adjacent area by laser beam irradiation is provided in the area of a part of the joint member, and the laser beam irradiation is started therefrom.

### BACKGROUND OF THE INVENTION

1. Field of the Invention

The present invention relates to a method of joining two members by locally heating a joint member provided between two members using laser beam. In particular, the present invention relates to a manufacturing method for an airtight container of a display panel.

2. Description of the Related Art

When a container that needs to maintain airtightness such an airtight container of a display panel is configured by a plurality of members, such plurality of members need to be joined at high adhesion and airtightness.

For example, when forming the airtight container with two substrates and a side wall provided between the two substrates, a method of providing a glass frit between the substrates and the side wall, and joining the substrates and the side wall through an intermediation of the glass frit by heating the glass frit is known.

Japanese Patent Applications Laid-Open No. 2000-251711, No. 2000-251720, and No. 2000-251722 describe a method of providing a glass frit between a substrate and a side wall, and radiating the glass frit by laser beam while heating the entire system to a temperature lower than a temperature necessary for joining by the glass frit.

### SUMMARY OF THE INVENTION

When joining two joining members by radiating the laser beam on a joint member provided between the two joining members, reduction in stress generated at the joint portion and realization of preferable adhesive strength are desired. Further, airtightness is also required on the joint portion in addition to the adhesive strength (adhesion) when joining the members to be used in the airtight container.

Under a molten state of metal or metal compound such as alloy, the absorption rate of the laser beam generally rises compared to a non-molten state (solid state). Thus, when the joint member (non-molten state) made of metal or metal compound such as alloy is caused to start melting by laser beam irradiation, the absorption rate of laser beam at the irradiation area of the laser beam rises during the laser beam irradiation, and the temperature at the relevant area rapidly rises.

On the other hand, in Japanese Patent Applications Laid-Open No. 2000-251711, No. 2000-251720, and No. 2000-251722, a spot-shaped laser beam is scanned in a closed-ring form along the surface of the joint member with respect to the joint member provided in a closed-ring form (closed-loop form) when forming the airtight container.

If the joint member is made of metal, alloy, or the like, the heat conductivity of the joint member is high. Thus, when the area (irradiation start area) of the joint member radiated first by the spot-shaped laser beam melts by the laser beam, the adjacent area, which is not yet radiated by the laser beam, adjacent to the irradiation start area also starts to melt by heat conduction.

Therefore, when scanning the spot-shaped laser beam, the laser beam is subsequently radiated on the adjacent area that already started to melt. If the laser beam is scanned without changing the intensity (power) of the laser beam, the intensity of the laser beam obviously has an intensity sufficient to melt the joint member in the non-molten state of the irradiation start area, and thus the intensity of the laser beam radiated on the adjacent area that already started to melt becomes an excess.

As a result, the molten joint member may scatter or large thermal stress may generate at the joining member, thereby predetermined airtightness and adhesion may not be obtained or the joint member may break.

However, if the intensity of the laser beam is decreased, the temperature of the joint member at the irradiation start area does not rise and preferable joint cannot be formed, thereby predetermined airtightness and adhesion may not be obtained.

The present invention is provided to solve the above-mentioned problems, and it is an object of the present invention to provide a joint method of realizing preferable joint with a simple method.

The present invention relates to a joint method of a first member and a second member by melting a joint member provided between the first member and the second member using a laser beam, including the steps of providing the joint member including a first area between the first member and the second member, and gradually melting a laser beam irradiation area of the joint member by scanning a laser beam such that the irradiation area of the joint member radiated by the laser beam of a constant intensity is gradually shifted from an area including the first area to an area outside the first area of the joint member, in which the laser beam has the intensity that maintains the area outside the first area in a non-molten state if the area outside the first area in the non-molten state only is irradiated by the laser beam, and maintains the area outside the first area in a molten state if the area outside the first area in the molten state is irradiated by the laser beam, and in which the first area is the area to be heated by the laser beam irradiation up to a temperature necessary to melt a region in the area outside the first area, the region being adjacent to the first area.

The present invention relates to a manufacturing method for an airtight container, the air tight container including a first substrate, a second substrate, and a side wall placed between the first substrate and the second substrate, and having an internal space defined by the first substrate, the second substrate and the side wall, the method including the steps of providing a joint member including a first area between at least one of the first and second substrates and the side wall; and gradually melting a laser beam irradiation area of the joint member by scanning a laser beam such that the irradiation area of the joint member radiated by the laser beam of a constant intensity is gradually shifted from an area including the first area of the joint member to an area outside the first area of the joint member; in which the laser beam has the intensity that maintains the area outside the first area in a non-molten state if the area outside the first area in the non-molten state only is irradiated by the laser beam, and maintains the area outside the first area in a molten state if the area outside the first area in the molten state is irradiated by the laser beam, and in which the first area is the area to be heated by the laser beam irradiation up to a temperature necessary to melt a region in the area outside the first area, the region being adjacent to the first area.

According to the present invention, the intensity of the laser beam does not need to be changed during irradiation, and joining with preferable adhesion and airtightness that does not generate excessive stress can be performed at lower intensity.

Further features of the present invention will become apparent from the following description of exemplary embodiments with reference to the attached drawings.

### BRIEF DESCRIPTION OF THE DRAWINGS

FIGS. 1A, 1B and 1C are views illustrating one example of an airtight container formed according to the present invention.

FIGS. 2A, 2B and 2C are views illustrating one example of a manufacturing method of the present invention.

FIGS. 3A, 3B, 3C and 3D are views illustrating one example of the manufacturing method of the present invention.

FIG. 4 is a view illustrating one example of a display panel.

FIG. 5 is a view illustrating the effects of the present invention.

FIG. 6 is a schematic cross-sectional view of a vicinity of a side wall of the airtight container of the present invention.

### DESCRIPTION OF THE EMBODIMENTS

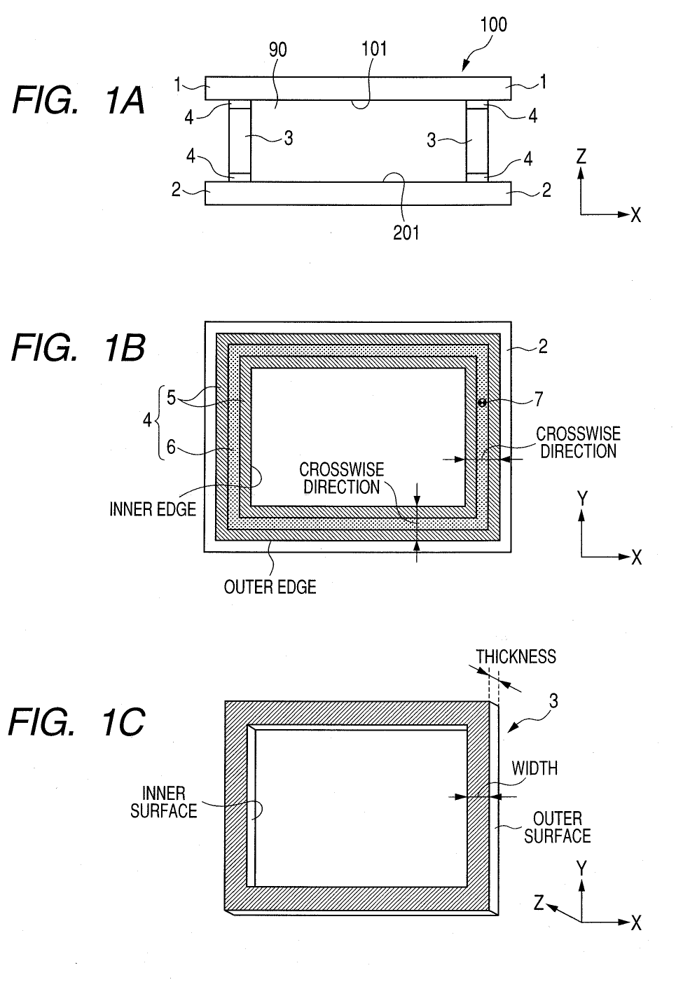

An airtight container 100 formed using a joint method according to the present invention is described with reference to FIGS. 1A and 1B. The airtight container 100 can be applied to an electronic component package, and an image display apparatus such as plasma display, field emission display, and surface-conduction electron emitter display.

FIG. 1A is a cross-sectional view of an example of the airtight container 100 that can be manufactured through the manufacturing method according to the present invention. The image display apparatus is configured by connecting a known drive circuit to the airtight container 100.

FIG. 1A illustrates a first substrate 1, a second substrate 2, a side wall 3, and a joint member 4. A main surface 101 of the first substrate 1 and a main surface 201 of the second substrate 2 face each other, and the side wall 3 is placed between the main surface 101 and the main surface 201. An internal space 90 of the airtight container 100 is surrounded by the first substrate 1, the second substrate 2, and the side wall 3. In this example, the joint member 4 has both airtightness and adhesion to form the airtight container 100.

In the example illustrated in FIG. 1A, the side wall 3 is illustrated to be formed with one member, but the side wall 3 may be formed with multiple members. The side wall 3 is a closed-ring member in plan view (in X-Y plane of FIGS. 1A, 1B and 1C). FIG. 1C illustrates a schematic perspective view of the side wall 3. The side wall 3 is a member of “square-shape”, “closed-loop shape” or “frame-shape”.

In the example illustrated in FIGS. 1A, 1B and 1C, the first substrate 1, the second substrate 2, and the side wall 3 are formed as different members. However, the first substrate and the side wall may be formed with one member, or the second substrate and the side wall may be formed with one member for the airtight container that can be made using the present invention. In other words, the joint member 4 is arranged only between the side wall 3 and the first substrate 1 or the second substrate 2.

The X direction and the Y direction are directions parallel to the main surface 101 and the main surface 201. The Z direction is a normal direction of the main surface 101 and the main surface 201. Alternatively, the Z direction is a direction in which the second substrate 2 and the first substrate 1 face each other (direction in which the main surface 101 and the main surface 201 face each other).

As illustrated in FIG. 1A, the container 100 has a frame-shaped side wall 3 sandwiched between the second substrate 2 and the first substrate 1. The joint member 4 is provided between the second substrate 2 and the side wall 3 and between the first substrate 1 and the side wall 3. In other words, the space (internal space 90) between the first substrate 1 and the second substrate 2 is surrounded by the side wall 3 and the joint member 4.

The gas (e.g., atmospheric air) of the external space is suppressed from flowing into the internal space 90 of the container 100 or the gas is suppressed from flowing out to the external space from the internal space 90 of the container 100 by sealing and adhering the substrate (1, 2) and the side wall 3 with the joint member 4.

At least part of the joint member 4 between the first substrate 1 and the side wall 3 and the joint member 4 between the second substrate 2 and the side wall 3 forms a joint portion 6 for joining the substrate (1, 2) and the side wall 3. The joint portion 6 is provided in a shape similar to the side wall 3 (closed-ring shape).

As described in detail hereinafter, by scanning in the closed-ring form while radiating at least part of the joint member 4 with the laser beam, the radiating area of the joint member 4 by the laser beam can be once melted, and then cooled to form the joint portion 6.

FIG. 1B is an X-Y plan view of one example of the container 100 illustrated in FIG. 1A, and is a view looking down at the container 100 from above the first substrate 1.

In FIG. 1B, a schematic view in which the first substrate 1 is removed from the container 100 is illustrated to describe the structure on the first substrate 1 side of the joint member 4.

FIG. 1B illustrates a non-joint portion 5 and the joint portion 6. As described in detail hereinafter, FIG. 1B illustrates an area (irradiation start area) 7 on the joint member 4 where the laser beam irradiation starts. Here, the shape of the irradiation start area 7 is a circle, but the shape is not limited to a circle.

The joint member 4 is provided between the side wall 3 and the first substrate 1 and between the side wall 3 and the second substrate 2 so as to surround the internal space 90. In other words, the joint member 4 is provided in a closed-ring form (closed-loop form), similar to the side wall 3. In other words, the joint member 4 is provided in the “square-shape”, the “closed-loop shape” or the “frame-shape”.

The joint portion 6 is also provided in a closed ring-form (closed loop-form) to maintain airtightness of the internal space 90. The joint portion 6 has a closed ring-form of a square in which one side is linear in FIG. 1B, but is not limited to such shape, and merely needs to be a closed ring-form and one side may be a wave-form.

The joint portion 6 is the portion where the substrate (1, 2) and the side wall 3 are joined by heating at least part of the joint member 4 by laser beam until it once melts, and then cooling and solidifying the joint member 4. In FIG. 1B, an example where the joint portion 6 is provided in a closed ring-form at the middle in the width direction of the joint member 4, and a non-joint portion 5 of closed ring-form is provided on the inner side and the outer side of the joint portion 6 is illustrated.

The non-joint portion 5 may serve as a spacer for defining a spacing between the substrate (1, 2) and the side wall 3. In other words, when fixing the joint member 4 to the side wall 3 in advance by adhesion and the like before radiating the laser beam, the joint member 4 can contact the substrate (1, 2) at the non-joining portion 5. When the joint member 4 is fixed to the substrate (1, 2) in advance by adhesion and the like before radiating the laser beam, the joint member 4 can contact the side wall 3 with the non-joining portion 5. When the joint member 4 is not adhered to the substrate (1, 2) nor the side wall 3 before radiating the laser beam, the non-joining portion 5 of the joint member 4 can contact both the side wall 3 and the substrate (1, 2). The non-joining portion 5 thus can be interpreted as “spacer”.

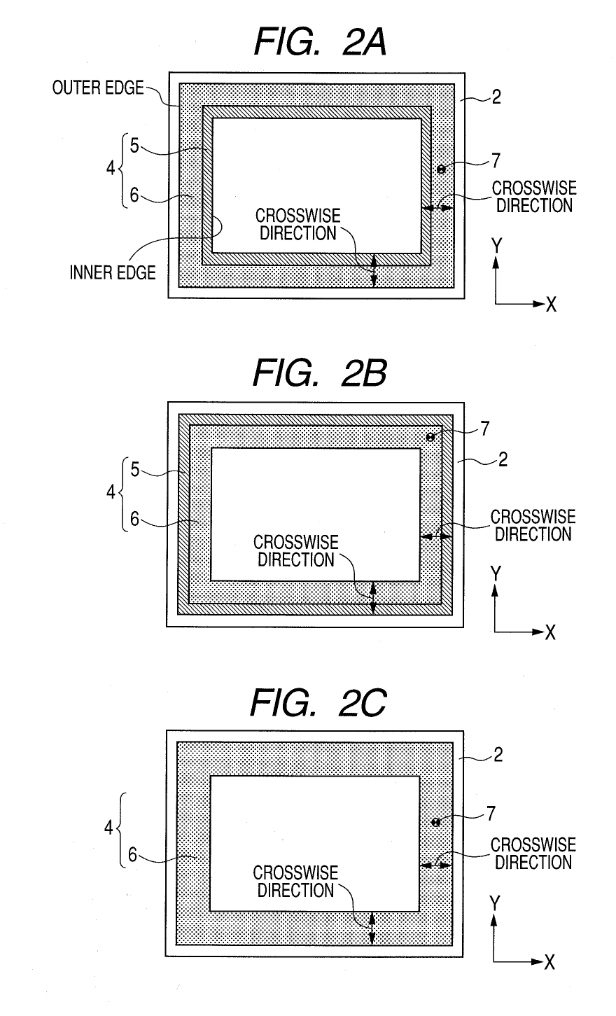

The pattern of the non-joining portion 5 and the joining portion 6 is not limited to the embodiment illustrated in FIG. 1B. For example, as illustrated in FIG. 2A, the non-joining portion 5 may be provided on the internal space 90 side, and the joining portion 6 may be provided on the external space side. Further, as illustrated in FIG. 2B, the non-joining portion 5 may be provided on the external space side, and the joining portion 6 may be provided on the internal space 90 side. Alternatively, as illustrated in FIG. 2C, the non-joining portion 5 may not be provided.

The term “join” in the present invention at least means adhering two members (two joining members) by a joint member. As illustrated in FIG. 1A, when joining two members to form the airtight container 100, the term “join” means hermetically closing (sealing) in addition to adhering.

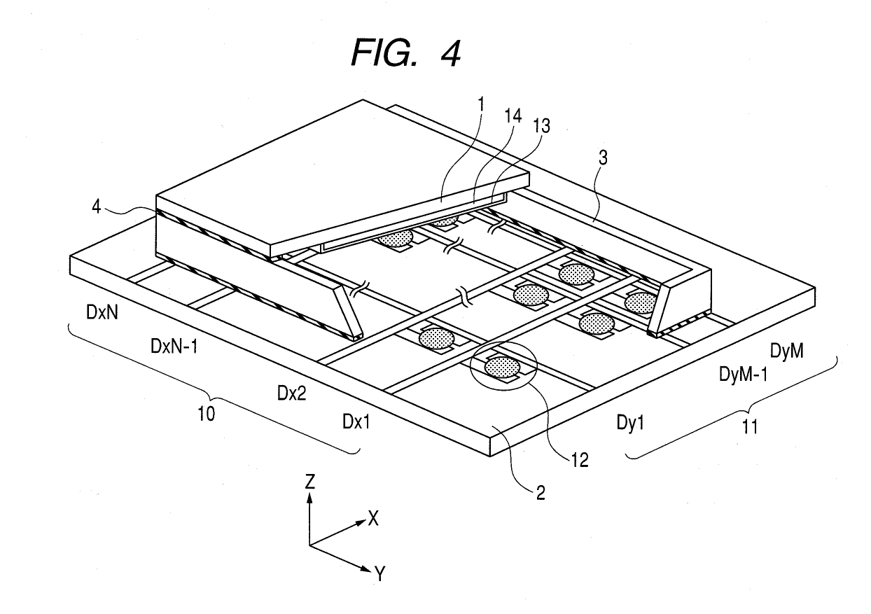

The display panel is formed by providing number of light emitting elements in the internal space of the airtight container 100. FIG. 4 illustrates an example in which the airtight container 100 is applied to an airtight container (display panel) for an image display apparatus.

In the example illustrated in FIG. 4, a first substrate 1 is a front substrate and a second substrate 2 is a rear substrate.

The front substrate (first substrate) 1 may be a glass substrate and the like. A light emitter 14 such as a phosphor and an anode 13 are arranged on a main surface 101 thereof. A so-called metal back may be used for the anode 13. A metal film such a aluminum film may be used for the metal back.

The rear substrate (second substrate) 2 may be a glass substrate and the like. An electron emitter 12 and wirings 10, 11 connected to the electron emitter may be provided on a main surface 201 thereof. In addition to a surface-conduction electron emitter, field emission electron emitter such as a Spindt type electron emitter and MIM-type electron emitter may be used for the electron emitter 12.

An image display apparatus such as field emission display and surface-conduction display is configured by connecting a known drive circuit to the display panel. In this example, the light emitting element is configured by the electron emitter and the light emitter. In the case of the image display apparatus using such electron beam, the pressure of the internal space 90 in the airtight container is maintained at a pressure lower than atmospheric pressure. The pressure of the internal space 90 is maintained to lower than or equal to 10⁻⁵ Pa for practical purposes. The external space of the airtight container 100 becomes the atmospheric pressure. It should be noted that although the first substrate 1 is the front substrate and the second substrate 2 is the rear substrate in the present example, it may be the other way around.

An organic EL display can be configured by providing an organic EL element in the airtight container 100 as a light emitting element. A plasma display (PDP) can be configured by providing an element for generating plasma and a light emitter in the airtight container 100 as a light emitting element. The airtight container used in such displays may have the internal space maintained at a pressure lower than the atmospheric pressure, or a predetermined gas enclosed in the internal space.

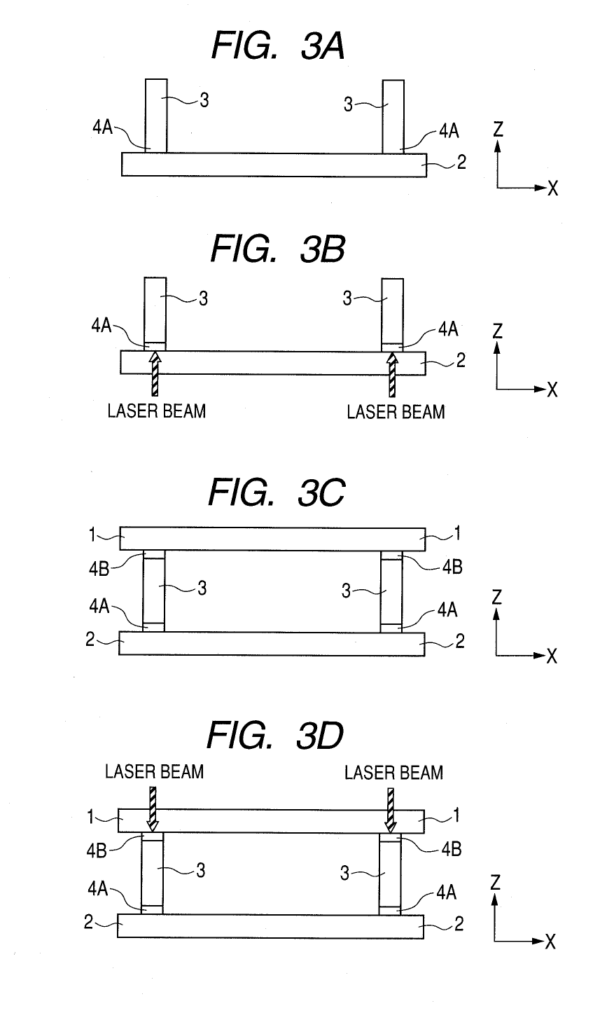

One example of a joint method of the present invention is described below with reference to FIGS. 3A to 3D using a manufacturing method of the airtight container 100 illustrated in a cross-sectional schematic view in FIG. 1A by way of example.

Steps 1 to 4, which are basic steps, are first described. Thereafter, the detail of joining by the laser beam (correspond to steps 2 and 4), which is the feature of the joint method of the present invention, is described.

(Step 1)

The substrate 2, the side wall 3 of closed ring-form, and the first joint member 4A of closed ring-form are prepared, and the first joint member 4A is provided between the second substrate 2 and the side wall 3 (FIG. 3A). In this case, the joint member 4A may be fixed to either the substrate 2 or the side wall 3, but may be mounted on either the substrate 2 or the side wall 3 without being fixed thereto.

(Step 2)

The first joint member 4A is scanned in the closed ring-form while radiating the laser beam thereto to heat the first joint member 4A, and thereafter, the first joint member 4A is cooled to join the substrate 2 and the side wall 3 (FIG. 3B).

(Step 3)

The first substrate 1 and a second joint member 4B of the closed ring-form are prepared, and the joint member 4B is placed between the first substrate 1 and the side wall 3 (FIG. 3C). In this case, the joint member 4B may be fixed to either the substrate 1 or the side wall 3, but may be mounted on either the substrate 1 or the side wall 3 without being fixed.

(Step 4)

Similarly to step 2, the second joint member 4B is scanned in the closed ring-form while radiating the laser beam to heat the second joint member 4B, and thereafter, the second joint member 4B is cooled to join the substrate 1 and the side wall 3 (FIG. 3D).

The container 100 illustrated in FIGS. 1A, 1B and 1C can be formed basically through the above-mentioned steps.

The container in which the internal space 90 has a pressure lower than that of the external space can be obtained by performing the above-mentioned steps in vacuum or in an atmosphere lower than atmospheric pressure. An exhaust hole may be formed in the substrate 1 or the substrate 2 to exhaust the internal space 90 through such exhaust hole after the steps 1 to 4 are terminated, and then sealing the exhaust hole to obtain the container in which the internal space 90 has a pressure lower than that of the external space.

The order of performing the steps 1 to 4 is not particularly limited as long as the container 100 can be formed. For instance, the order may be step 1, step 3, step 2, and step 4, or may be step 3, step 4, step 1, and step 2. Steps 2 and 4 may be simultaneously carried out after performing step 1 and step 3. Therefore, each step may be performed separately in order, or a plurality of steps may be simultaneously performed in parallel. In the embodiment where the first substrate or the second substrate and the side wall are configured by one member, either step 2 or step 4 is unnecessary. In other words, step 3 or step 4 is unnecessary if the first substrate and the side wall are integrally formed (or joined in advance). Further, step 1 or step 2 is unnecessary if the second substrate and the side wall are integrally formed (or joined in advance).

In step 1 and step 3, the joint member (4A, 4B) is arranged in a closed ring-form to cover the surface on the substrate (1, 2) side of the side wall 3. In other words, the joint member (4A, 4B) is arranged so that a gap is not formed between the side wall 3 and the substrate (1, 2) to air-tightly maintain the internal space 90.

For the material of the substrate (1, 2), quartz glass, glass with reduced impurity content such as Na and the like, soda lime glass, laminated body in which SiO₂ is laminated on the soda lime glass through sputtering method and the like may appropriately used. The substrate (1, 2) merely needs to have a predetermined strength. As illustrated in FIGS. 3B and 3D, when radiating the laser beam to the joint member (4A, 4B) through the substrate (1, 2), the material having high transmissivity to the laser beam used is used for the substrate (1, 2).

As illustrated in FIG. 1C, the side wall 3 is a member of closed ring-shape (“square-shape”, “closed-loop shape” or “frame-shape”). Generally, the outer periphery of the side wall 3 is a square in plan view. If the outer periphery of the side wall 3 is a square, the square side wall 3 can be formed by welding linear members, each of which corresponds to the four sides. Alternatively, the square side wall 3 can be formed by hollowing out the inner side of the plate-shaped member having an outer periphery of a square shape (square) along the outer periphery into a square shape. The material of the side wall 3 may be the material similar to that of the substrate (1, 2), and material of low light transmissivity such as metal and metal oxide may also be used.

The material of low heat conductivity compared to the heat conductivity of the joint member 4 is preferably selected for the side wall 3 and the substrate (1, 2) to efficiently heat a predetermined portion (joining portion 6 to be hereinafter described) of the joint member 4 by the laser beam.

The joint member (4A, 4B) is arranged on the surface facing the substrate (1, 2) of the side wall 3 or arranged on the portion facing the side wall 3 of the substrate (1, 2) using a dispenser method and the like. The joint member (4A, 4B) molded into a frame shape, which is a shape similar to that of the side wall 3, may be mounted in advance on the surface facing the substrate (1, 2) of the side wall 3 or mounted on the portion facing the side wall 3 of the substrate (1, 2).

Metal or metal compound such as alloy is preferably used for the material of the joint member (4A, 4B). In particular, metal (pure metal) having purity of more than or equal to 99% or alloy is preferably used. The material used for the joint member desirably has the temperature necessary for forming the joining portion 6, which does not exceed the melting point or the softening point of the material of the side wall 3 and the substrate (1, 2). For instance, if glass is used for the side wall 3 and the substrate (1, 2), indium, aluminum, and the like can be suitably used for the metal, in particular, aluminum is preferable due to its low cost and easiness in handling. If aluminum is used for the metal used for the joint member, a natural oxide film is formed on the surface.

YAG laser, semiconductor laser, Co₂ laser, and the like can be used for the laser beam used in steps 2 and 4.

The intensity of the laser beam used needs to be the intensity capable of maintaining the molten state of the joint member (4A, 4B) when radiated on the joint member (4A, 4B) in the molten state. The intensity of the laser beam used also needs to be the intensity capable of maintaining the joint member of the irradiation area in the non-molten state if only the area of the joint member in the non-molten state is radiated by the laser beam.

Although described in detail hereinafter, the intensity of the laser beam necessary for melting the metal joint member of non-molten state without using the area in which the temperature easily rises of the present invention to be hereinafter described needs to be at least 1.3 times the intensity of the laser beam necessary for maintaining the molten state of the metal joint member of molten state. Therefore, the intensity of the laser beam used depends on the joint member used.

For instance, the intensity of the laser beam necessary for melting the joint member used can be experimentally obtained in advance by gradually raising the intensity of the laser beam to be radiated on the joint member. The intensity of the laser beam necessary for maintaining the molten state of the joint member can also be experimentally obtained in advance by gradually raising the intensity of the laser beam to be radiated on the joint member, and after once melting the joint member, gradually reducing the intensity of the laser beam.

In the embodiments illustrated in FIGS. 3B and 3D, the joint member (4A, 4B) is radiated by the laser beam through the substrate (1, 2) transparent with respect to the laser beam. In the present invention, however, the laser beam may be radiated from the side surface of the joint member as in the prior art without being transmitted through the substrate (1, 2). However, in order to obtain preferable airtightness and adhesion, the laser beam is preferably radiated to the joint member (4A, 4B) through the substrate (1, 2) as illustrated in FIGS. 3B and 3D.

The irradiation of the laser beam to the joint member (4A, 4B) is described with reference to FIGS. 1B, 2A, 2B and 2C.

In steps 2 and 4, the laser beam of a constant intensity (power) is scanned while being radiated to make one round (in the closed ring-form) along the surface of the joint member (4A, 4B) provided in the closed ring-form. The area melted once by being radiated with the laser beam and then cooled and solidified of the joint member (4A, 4B) becomes the joining portion 6 for joining the side wall 3 and the substrate (1, 2). The solidification (cooling) of the molten joint member may be positively carried out using a cooling means or may be carried out by natural cooling.

The phrase “laser beam of constant intensity” does not include a mode of intentionally changing the intensity of the laser beam being radiated to the joint member. However, the device for radiating the laser beam includes slight unique fluctuation such as fluctuation of the power supply potential at the light source for emitting the laser beam. Thus, the relevant phrase does not exclude the slight unique fluctuation of the laser beam emission device.

The laser beam is preferably scanned with the irradiation start area (first area) 7 of the joint member (4A, 4B) as the starting point. Therefore, the irradiation area of the laser beam gradually moves from the irradiation start area 7 of the joint member (4A, 4B) to the area outside the irradiation start area. When forming the joining portion 6 to the closed ring-form, the laser beam is preferably first radiated on the irradiation start area (first area) 7, and then the irradiation area of the laser beam is gradually moved in the closed ring-form on the joint member 4 in the clockwise direction or the counterclockwise direction in FIGS. 1B, 2A, 2B and 2C. Even if the area distant from the area other than the first area is radiated by the laser beam, such area is not effectively melted. Thus, the laser beam may be radiated on other area (second area) excluding the first area 7 of the joint member before radiating the laser beam on the first area 7. In other words, the laser beam may be scanned such that irradiation of the laser beam to the joint member starts from the other area excluding the first area 7 of the joint member, and then the irradiation area of the laser beam reaches the first area 7. After the laser beam reaches the first area 7, the laser beam is scanned so as to gradually move in the closed ring-form on the joint member 4 in the clockwise direction or the counterclockwise direction similarly to the above.

A well-known method can be adopted for the method of scanning the laser beam. For instance, the laser beam may be scanned by relatively moving the laser beam output unit of the laser beam emission device with respect to the substrate (1, 2), or the laser beam may be scanned using a diffraction element. The surface of the joint member 4 then can be scanned with the laser beam with a predetermined pattern such as the closed ring-form. The scanning speed is appropriately selected in view of the relationship with the intensity or the spot diameter of the laser beam to use, the material of the joint member, and the like. For example, the scanning speed is preferably between 20 mm/sec. and 30 mm/sec. This range is a condition of when the joint member is made of aluminum, and the intensity of the laser beam (satisfying the necessary intensity in the present invention described above) is between 2.5 W/mm² and 6 W/mm² (output of the light source is between 100 W and 200 W, and the spot diameter φ is between 1 mm and 5 mm). Thus, the intensity, the spot diameter, and the scanning speed of the laser beam to be used are appropriately set according to the material of the joint member.

In FIG. 1B, the irradiation start area 7 is provided at the central part in the width direction of the joint member 4. An example of scanning the laser beam while radiating the joint member so as to form the joining portion 6 into the closed ring-form is illustrated. In the present invention, however, a mode of scanning the laser beam while radiating so as to provide the non-joining portion 5 on the internal space 90 side, and provide the joining portion 6 on the external space side, as illustrated in FIG. 2A, may be adopted. Further, a mode of scanning the laser beam while radiating so as to provide the non-joining portion 5 on the external space side, and provide the joining portion 6 on the internal space 90 side, as illustrated in FIG. 2B, may be adopted. Moreover, a mode of scanning the laser beam while radiating the entire surface facing the substrate (1, 2) of the joint member (4A, 4B) so as not to provide the non-joining portion 5, as illustrated in FIG. 2C, may be adopted.

The spot shape of the laser beam used in the present invention is not limited to ring. However, the spot shape of the laser beam can be ring in view of easiness in handling, and symmetric property and uniformity of the distribution in the spot. The size of the spot of the laser beam is selected according to the length in the width direction of the joining portion 6. For instance, the spot diameter is designed to be smaller than the length in the width direction of the joint member 4 to obtain the joining portion 6 illustrated in FIG. 1B.

An area (first area) where the temperature easily rises is provided in at least one part of the area (irradiation start area) 7 where the laser beam is radiated first in the joint member (4A, 4B).

The area where the temperature easily rises is the area where the temperature rises higher than other areas (second area) of the joint member when the laser beam of the same intensity is radiated. The area where the temperature easily rises has a function of rising to the temperature sufficient to melt the area of the joint member 4 which, by nature, does not melt at the intensity of the radiated laser beam and is adjacent to at least the area where the temperature easily rises by radiating the laser beam of the above-mentioned intensity.

Thus, when the laser beam is first radiated on the irradiation start area 7, the temperature of the area where the temperature easily rises rapidly rises, and the area adjacent to the irradiation start area 7 starts to melt by heat conduction. Thereafter, the laser beam is scanned, and thus the area outside the irradiation start area in the adjacent area that started to melt is radiated by the laser beam. Because the adjacent area is melting (melting temperature is reached), the area outside the irradiation start area or the area adjacent to such area (area not yet radiated by laser beam) newly starts to melt by heat conduction. The laser beam is then scanned, and thus the laser beam is thereafter radiated to the area that newly started to melt. The adjacent area (area not yet radiated by laser beam) then starts to melt. In the joint method of the present invention, such chain of phenomenon is repeatedly performed. As a result, the intensity of the laser beam is suppressed, the predetermined area of the joint member (4A, 4B) is gradually melted, and the predetermined joining portion can be formed.

The shape of the irradiation start area 7 is circular herein, but is not limited to circular. The shape of the irradiation start area 7 may be the same as the spot shape of the laser beam.

If all of the irradiation start area 7 is the area where the temperature easily rises, the irradiation start area 7 can be smaller than the spot shape of the laser beam (fit within the spot of the laser beam). In this case, the area where the temperature easily rises has a shape smaller than the spot shape of the laser beam (fitted within the spot of the laser beam).

The member constituting the area where the temperature easily rises can exhibit adhesion and/or airtightness between the substrate (1, 2) and the side wall 3 by heating by the laser beam, but merely needs to melt the joint member 4 adjacent to at least the area where the temperature easily rises. In other words, the area where the temperature easily rises may not necessarily melt. However, if the area where the temperature easily rises does not exhibit airtightness by heating by the laser beam, consideration needs to be made such that the internal space 90 and the external space do not communicate through an intermediation of the area where the temperature easily rises. For instance, as illustrated in FIGS. 1B, 2A, 2B and 2C, one part of the joining portion 6 always needs to exist between the area where the temperature easily rises and the internal space 90.

The area where the temperature easily rises can be formed by adopting the mode in which the absorption rate of the laser beam is larger or the mode in which the heat capacity is smaller compared to the joint member 4 of the area other than the area where the temperature easily rises.

In order to form the area where the temperature easily rises, the joint member 4 is prepared all with the same material, and the surface roughness of the area (area to be the area where the temperature easily rises) of part of the joint member 4 is set to a predetermined surface roughness. The absorption rate of the laser beam of the area to become the area where the temperature easily rises then can become higher than the absorption rate of the laser beam of the area other than the area to become the area where the temperature easily rises.

If aluminum is used for the joint member 4, the intensity of the laser beam capable of melting aluminum is experimentally known to be at least 1.3 times the intensity necessary for maintaining the molten state of the already melted aluminum. Therefore, the absorption rate of the laser beam of the area where the temperature easily rises is set to be greater than or equal to 1.3 times the absorption rate of the laser beam of the area other than the area where the temperature easily rises.

More specifically, the surface roughness of the area (area to become the area where temperature easily rises) of part of the joint member 4 can be differed from the surface roughness of other areas by partially melting and coagulating or polishing.

For instance, the joint member 4 is made of metal, and the surface roughness (10 point average roughness: Rz) of the area to become the area where the temperature easily rises is set to be greater than or equal to 0.4λ and smaller than or equal to 0.6λ, where λ(μm) is the wavelength of the laser beam to be used. The surface roughness of other areas is outside the range (e.g., 0.1λ or 1λ). The area to become the area where the temperature easily rises can be set as the area for efficiently absorbing the laser beam by greater than or equal to 1.3 times the area adjacent to the relevant area by setting the incident angle of the laser beam with respect to the joint member to greater than or equal to 80 degrees and smaller than or equal to 100 degrees.

As the surface roughness becomes smaller than the range, the laser beam is regularly reflected and is less likely to be absorbed by the joint member 4. As the surface roughness becomes greater than the range, on the other hand, the ratio of diffused reflection at the joint member 4 becomes larger, and in this case, the amount of heat absorbed by the joint member 4 also reduces.

Regardless of the polarization state such as linear polarization and circular polarization, and the type of laser light source, the metal film has high absorption rate at the surface roughness of the above-mentioned range. The absorption rate when the surface roughness is outside the above-mentioned range decreases compared to when the surface roughness of the above-mentioned range. Thus, the absorption rate of the laser beam 7 does not change according to the characteristics of the laser beam 7, but depends on the surface roughness.

Alternatively, the film thickness of the oxide coating of the area (area to become the area where the temperature easily rises) of part of the joint member 4 is made thinner than that of the oxide coating of other areas, and hence the heat capacity reduces, and the area where the temperature easily rises can be formed. The required film thickness of the oxide coating can be experimentally obtained by preparing multiple joint members having different film thickness of the oxide coating for the laser beam to be actually used.

Alternatively, when radiating the laser beam through the substrate (1, 2), the area where the temperature easily rises can be formed by arranging a material different from the joint member such as black material (material that easily absorbs laser beam) on the surface facing the substrate of the joint member (4A, 4B). When using alloy for the joint member (4A, 4B), the area where the temperature easily rises can be formed by partially changing the component ratio of the joint member.

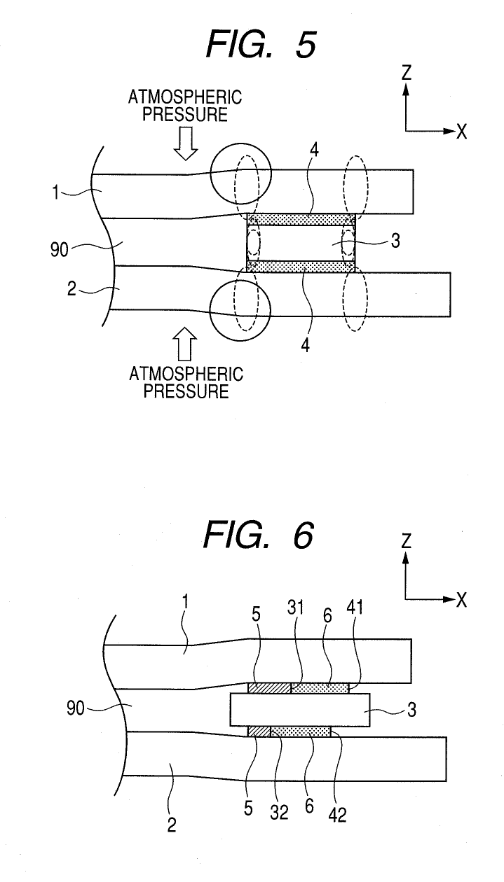

Next, in the airtight container 100 having the configuration illustrated in FIG. 1A, problems may arise if the joining portion 6 between the side wall 3 and the substrate 1 and the joining portion 6 between the side wall 3 and the substrate 2 have the pattern illustrated in FIG. 2A. This problem is described with reference to FIG. 5. FIG. 5 is a schematic cross-sectional view in which the vicinity of the side wall 3 of the airtight container 100 is enlarged.

A large residual stress generates at the portions of the substrate 1 and the side wall 3, which are schematically illustrated in an ellipse of dotted line of FIG. 5, close to the end on the internal space 90 side and the external space side of the joint member 4 (joining portion 6) between the substrate 1 and the side wall 3. A large residual stress also generates at the portions of the substrate 2 and the side wall 3, which are schematically illustrated in an ellipse of dotted line of FIG. 5, close to the end on the internal space 90 side and the external space side of the joint member 4 (joining portion 6) between the substrate 2 and the side wall 3.

The stress caused by forming the joining portion 6 between the first substrate 1 and the side wall 3 and the stress caused by forming the joining portion 6 between the second substrate 2 and the side wall 3 overlap on the side wall 3 because the spacing between the substrate 1 and the substrate 2 is smaller than 10 mm, thereby the residual stress becomes large. In particular, the residual stress becomes significant because the substrates 1, 2 and the side wall 3 are joined by melting the joint member 4 with the laser beam.

When maintaining the internal space 90 of the airtight container 100 in vacuum or at a pressure lower than the atmospheric pressure, the bending stress by the atmospheric pressure generates at the portion (portion schematically illustrated with a circle of solid line of FIG. 5) of the front substrate 1 and the rear substrate 2 close to the end on the internal space 90 side of the substrate (1, 2).

When the positions where the residual stress and the bending stress generate overlap as illustrated in FIG. 5, the substrate 1 and the substrate 2 tend to easily break. The side wall 3 also tends to easily break. As a result, the reliability of the airtight container is degraded.

This problem becomes very important when making the thickness of the substrates 1, 2 thinner or when making the thickness of the side wall 3 thinner (spacing between the substrate 1 and the substrate 2 becomes narrower). This problem becomes more important when the material of the substrate 1, 2 and/or the side wall 3 is glass.

The non-joining portion 5 (spacer) is provided between the side wall 3 and the substrate 1, 2 on the internal space 90 side of the airtight container 100 with respect to the joining portion 6 to reduce the stress generated at the airtight container 100. According to such configuration, the overlap of the positions where the residual stress and the bending stress generate can be reduced. As a result, the concentration of stress generated at the substrate 1 and the substrate 2 can be reduced.

As illustrated in FIG. 6, the positions of the ends (31, 32, 41, 42) of the joining portion 6 are differed in the width direction (direction perpendicular to the direction in which the substrate 1 and the substrate 2 face each other) of the side wall 3. In this way, the stress generated at the side wall 3 due to the joining of the substrate (1, 2) and the side wall 3 then can be also reduced. Specifically, the joining portion 6 at the first joint member 4A between the first substrate 1 and the side wall 3 and the joining portion 6 at the second joint member 4B between the second substrate 2 and the side wall 3 can have different patterns. Such mode can be obtained by forming the joining portion 6 at the first joint member 4A with the pattern of FIG. 2A and the joining portion 6 at the second joint member 4B with the pattern of FIG. 2B. Alternatively, such mode can be obtained by forming the joining portion 6 at the first joint member 4A with the pattern of FIG. 1B and the joining portion 6 at the second joint member 4B with the pattern of FIG. 2B.

In order to also reduce the stress generated at the side wall 3, a mode in which the positions of both ends (31, 41) of the joining portion 6 between the side wall 3 and the substrate 1 and the positions of both ends (32, 42) of the joining portion 6 between the side wall 3 and the substrate 2 are completely different is most preferable. However, the effects can be obtained with the mode in which the positions of the ends (31, 32) on the internal space 90 side of both ends of the joining portion 6 are at least different from each other.

Accordingly, the overlap of the stress caused by forming the joining portion 6 between the first substrate 1 and the side wall 3 and the stress caused by forming the joining portion 6 between the second substrate 2 and the side wall 3 at the side wall 3 can be reduced. The reliability of the airtight container can be enhanced as a result.

### FIRST EXAMPLE

Next, a manufacturing method for the container 100 illustrated in FIGS. 1A, 1B and 1C formed in this example is described with reference to FIGS. 3A, 3B, 3C and 3D.

(First Step)

The second substrate 2 made of glass, the side wall 3 made of glass, and the first joint member 4A made of aluminum are prepared, and the first joint member 4A is provided between the second substrate 2 and the side wall 3 (FIG. 3A).

The joint member 4A is arranged over the entire periphery of the side wall 3 so as to cover the surface on the second substrate 2 side of the side wall 3. That is, the joint member 4A is arranged in the closed ring-form to define the internal space 90.

The joint member 4A is configured by an aluminum sheet (width of 3 mm, thickness of 0.1 mm) mounted on a surface facing the second substrate 2 of the side wall 3 and processed to a frame shape in advance. The Rz of the surface of part of the frame-shaped aluminum sheet, which has the same size as the irradiation start area 7 of the laser beam, is roughened in advance so as to be 0.5λ with respect to the wavelength λ of the laser beam to be used. The roughened area 7 becomes the area where the temperature easily rises (area that easily melts). The surface roughness of the area other than the area where the temperature easily rises is 0.1λ.

(Second Step)

The surface on the second substrate 2 side of the first joint member 4A is locally heated by scanning while being radiated with the laser beam of YAG laser transmitted through the second substrate 2. Here, the laser beam is radiated with the pattern similar to FIG. 1B. In other words, the laser beam having the scanning speed of 25 mm/sec and the intensity of 3 W/mm² is radiated so as to provide the non-joining portion (spacer) 5 on the internal space 90 side and the external space side so as to sandwich the joining portion 6.

The joining portion 6 is an area spaced apart by about 0.5 mm from the end on the inner side of the joint member 4A, and spaced apart by about 0.5 mm from the end on the outer side. In other words, the non-joining portion (spacer) 5 having a width of about 0.5 mm is provided on the inner side and the outer side of the joining portion 6.

One part of the joint member 4A is melted through local heating, and thereafter, naturally cooled and solidified to thereby form the joining portion of the second substrate 2 and the side wall 3.

(Third Step)

The first substrate 1 made of glass, and the second joint member 4B made of aluminum processed to a frame shape in advance are prepared, and the second joint member 4 is sandwiched between the first substrate 1 and the side wall 3 (FIG. 3C). The first joint member 4A and the second joint member 4B have the same shape (width of 3 mm, thickness of 0.1 mm). The Rz of the surface of part of the second joint member 4B (area where the temperature easily rises), which has the size same as the irradiation start area 7 of the laser beam, is roughened in advance to become 0.5λ with respect to the wavelength λ of the laser beam to be used, similar to the first step. The surface roughness of the area other than the area where the temperature easily rises is 0.1λ.

(Fourth Step)

The second joint member 4B is locally heated by scanning, while being radiated with the laser beam transmitted through the first substrate 1, the surface on the first substrate 1 side of the second joint member 4B with the condition similar to the second step (FIG. 3D). Here, the laser beam is radiated with the pattern similar to FIG. 2A. The joining portion 6 is a range of 2 mm from the end on the inner side of the joint member 4B. That is, the non-joining portion (spacer) 5 having a width of 1 mm is provided on the outer side of the joining portion 6.

In this example, the end position on the internal space 90 side of the joining portion 6 between the side wall 3 and the first substrate 1 and the end position on the internal space 90 side of the joining portion 6 between the side wall 3 and the second substrate 2 are prevented from overlapping one above the other similar to the example illustrated in FIG. 6.

(Fifth Step)

Subsequently, after the internal space 90 of the airtight container is exhausted in vacuum through the exhaust hole (not shown) formed in the first substrate 1, the exhaust hole is sealed, and the vacuum airtight container 100 is formed.

Through the above-mentioned steps, the airtight container with reduced stress having high airtightness and preferable joint strength can be formed using the laser beam of constant intensity.

The field emission type electron emission element is arrayed and formed in great numbers on the first substrate 1 similar to this example, and the phosphor and the anode electrode are provided on the second substrate 2 similar to this example to make the field emission display (FED). AS a result, the airtight container does not break by stress, the vacuum degree of the interior can be maintained over a long period of time, and a preferable display image can be displayed over a long period of time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-123438, filed May 9, 2008, which is hereby incorporated by reference herein in its entirety.

What is claimed is:

1. A manufacturing method of an airtight container, the airtight container comprising a first substrate, a second substrate, and a side wall placed between the first substrate and the second substrate, and having an internal space defined by the first substrate, the second substrate and the side wall, the method comprising the steps of:
providing a joint member including a first area between at least one of the first and second substrates and the side wall; and
gradually melting a laser beam irradiation area of the joint member by scanning a laser beam such that the irradiation area of the joint member radiated by the laser beam of a constant power is gradually shifted from the first area of the joint member to an area outside the first area of the joint member;
wherein the laser beam has the power that maintains the area outside the first area in a non-molten state if the area outside the first area in the non-molten state only is irradiated by the laser beam, and maintains the area outside the first area in a molten state if the area outside the first area in the molten state is irradiated by the laser beam,
wherein the first area is the area to be heated by the laser beam irradiation up to a temperature necessary to melt a region in the area outside the first area, the region being adjacent to the first area.

2. The manufacturing method of the airtight container according to claim 1, wherein a laser beam absorption rate of the first area is greater than a laser beam absorption rate of the area outside the first area.

3. The manufacturing method of the airtight container according to claim 1, wherein a heat capacity of the first area is less than a heat capacity of the area outside the first area.

4. The manufacturing method of the airtight container according to claim 1, wherein a surface roughness of the first area is different from a surface roughness of the area outside the first area.

5. The manufacturing method of the airtight container according to claim 1, wherein the joint member comprises a metal.

6. A manufacturing method of a display panel on which a plurality of light emission elements are provided in an internal space of an airtight container, the airtight container manufactured by the manufacturing method according to claim 1.

7. A joint method of a first member and a second member by melting a joint member provided between the first member and the second member using a laser beam, comprising the steps of:
providing the joint member including a first area between the first member and the second member; and
gradually melting a laser beam irradiation area of the joint member by scanning a laser beam such that the irradiation area of the joint member radiated by the laser beam of a constant power is gradually shifted from the first area of the joint member to an area outside the first area of the joint member;
wherein the laser beam has the power that maintains the area outside the first area in a non-molten state if the area outside the first area in the non-molten state only is irradiated by the laser beam, and maintains the area outside the first area in a molten state if the area outside the first area in the molten state is irradiated by the laser beam,
wherein the first area is the area to be heated by the laser beam irradiation up to a temperature necessary to melt a region in the area outside the first area, the region being adjacent to the first area.

8. The joint method according to claim 7, wherein a laser beam absorption rate of the first area is greater than a laser beam absorption rate of the area outside the first area.

9. The joint method according to claim 7, wherein a heat capacity of the first area is less than a heat capacity of the area outside the first area.

10. The joint method according to claim 7, wherein a surface roughness of the first area is different from a surface roughness of the area outside the first area.

11. The joint method according to claim 7, wherein the joint member comprises a metal.
